(19) United States
(12) Patent Application Publication
(10) Pub. No.: US 2019/0346409 A1
(43) Pub. Date: Nov. 14, 2019

(54) SENSOR

(71) Applicant: TEKNOLOGIAN TUTKIMUSKESKUS VTT OY, Espoo (FI)

(72) Inventor: Panu KOPPINEN, Espoo (FI)

(21) Appl. No.: 16/461,521

(22) PCT Filed: Nov. 23, 2017
(86) PCT No.: PCT/FI2017/050816

§ 371 Date: May 16, 2019

(30) Foreign Application Priority Data
Nov. 24, 2016 (FI) 20165894

(51) Int. Cl. G01N 29/22; G01N 29/24; G01N 29/02; G01N 29/024

(52) U.S. Cl. CPC G01N 29/222; G01N 29/223; G01N 29/2437; G01N 2291/021; G01N 29/022; G01N 29/024; G01N 2291/014; G01N 29/2406

(57) ABSTRACT

A sensor (1) comprises a transducer (2), a base plate (3) comprising a space (4) for accommodating the transducer (2), and a silicon-on-insulator plate (5) on top of the base plate (3). The base plate (3) forms a frame for the transducer (2) and the silicon-on-insulator plate (5) at least partly defines a horizontally and vertically extending cavity (6) arranged in connection with the transducer (2). The sensor (1) further comprises a top element (7) on top of the silicon-on-insulator plate (5) for terminating the cavity (6).

### FIELD OF THE INVENTION

The present invention relates to a sensor and especially to a sensor applicable to be used in microelectromechanical systems or devices.

### BACKGROUND OF THE INVENTION

A sensor to be used in microelectromechanical systems or devices comprises an ultrasonic transducer and a cavity on top of the transducer. The dimensions of the cavity are tried to be selected in such a way that a resonance condition is met at the operating frequency of the transducer. The sensor like that may be used for example for measuring pressure, variation in acoustic pressure, a magnetic field, acceleration, vibration or a composition of a gas.

A problem relating to a prior art sensor is a macroscopic dimensioning of the cavity, in some cases the size of the cavity being even many centimeters in lateral dimensions. The required precision of manufacture of the cavity like that relative to the resonance condition is difficult to achieve. Furthermore, the large size of the cavity of the sensor also inevitably increases a size of the sensor and therefore also a size of the system or device where it is intended to be arranged to.

### BRIEF DESCRIPTION OF THE INVENTION

An object of the present invention is to provide a novel sensor applicable to be used in microelectromechanical systems or devices.

The invention is characterized by the features of the independent claim.

The invention is based on the idea of having a sensor comprising an ultrasonic transducer, a base plate comprising a space for accommodating the transducer and a silicon-on-insulator plate on top of the base plate, wherein the base plate forms a frame for the transducer and the silicon-on-insulator plate at least partly defines a horizontally and vertically extending resonance cavity arranged in connection with the transducer. Furthermore the sensor comprises a top element on top of the silicon-on-insulator plate for terminating the cavity.

An advantage of the invention is that it may be provided a stacked sensor construction made out of three wafers and the transducer, whereby the sensor 1 has a simple and compact miniaturized structure which can be manufactured in a simple way.

Some embodiments of the invention are disclosed in the dependent claims.

### BRIEF DESCRIPTION OF THE DRAWINGS

In the following the invention will be described in greater detail by means of preferred embodiments with reference to the accompanying drawings, in which

FIG. 1 shows schematically an axonometric view of a sensor;

FIG. 2 shows schematically an axonometric view of a part of the sensor of FIG. 1;

FIG. 3 shows schematically an axonometric view of a part of the sensor of FIG. 1;

FIG. 4 shows schematically an axonometric view of a transducer of the sensor of FIG. 1;

FIG. 5 shows schematically a cross-sectional side view of a sensor according to FIG. 1;

FIG. 6 shows schematically an axonometric view of a part of a second sensor; and

FIG. 7 shows schematically a cross-sectional side view of a third sensor.

For the sake of clarity, the figures show some embodiments of the invention in a simplified manner. Like reference numerals identify like elements in the figures.

### DETAILED DESCRIPTION OF THE INVENTION

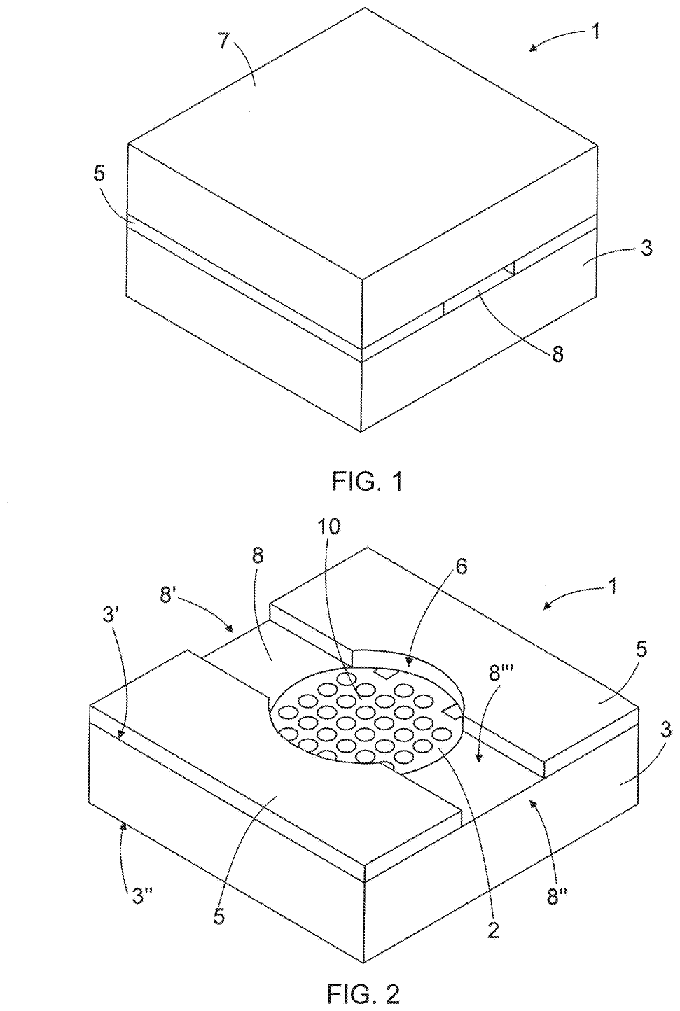

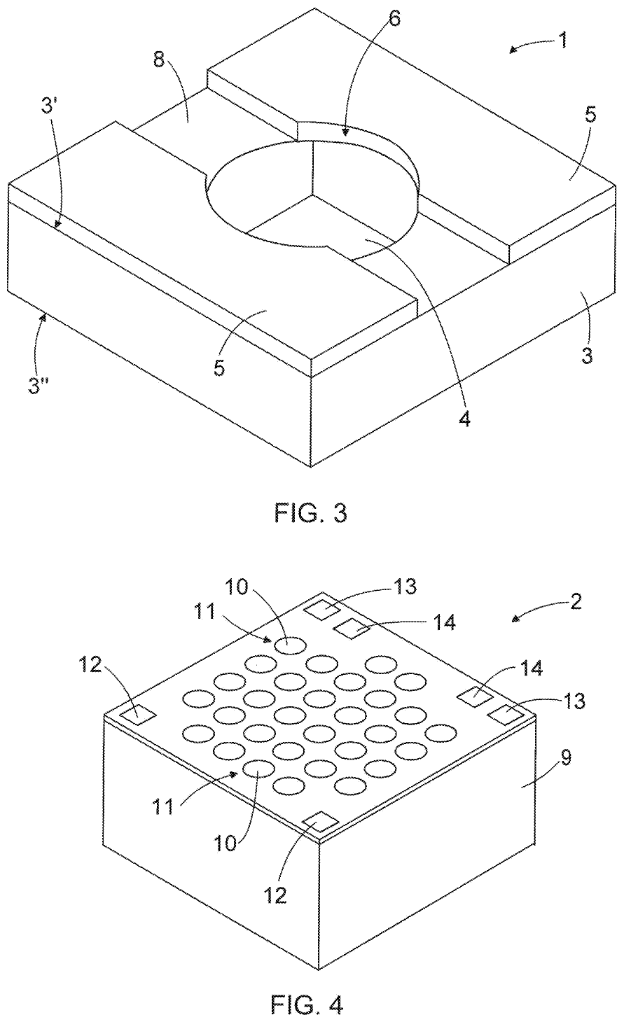

FIG. 1 shows schematically an axonometric view of a sensor 1. FIG. 2 shows schematically an axonometric view of a part of the sensor 1 of FIG. 1 and FIG. 3 also shows schematically an axonometric view of a part of the sensor 1 of FIG. 1. The sensor 1 comprises an ultrasonic transducer 2 being connected to or being in connection with an acoustic resonance cavity 6. Some examples of sensors like that are disclosed in the following description.

The ultrasonic transducer 2 is configured to put out or emit as well as to receive or absorb ultrasound or ultrasonic waves or both to put out and receive ultrasound or ultrasonic waves. The ultrasound or ultrasonic waves may for example be applied in an identification of a substance or an agent, in a measurement of a property of a substance or an agent, in a measurement of a physical magnitude of a phenomenon, such as sound or voice, to be measured by the sensor 1. FIG. 4 shows schematically an axonometric view of a transducer 2 which may be applied in the sensor 1.

The sensor 1 comprises a base plate 3. The base plate 3 provides a body of the sensor 1. The base plate 3 comprises a space 4 or a room 4 for accommodating the transducer 2 in the sensor 1. The base plate 3 thus provides or forms a frame or a holder for the transducer 2. According to an embodiment the base plate 3 is formed of a silicon wafer but the base plate may be made of any other material applicable to be used for providing the base of the frame for the transducer 2.

In the embodiment of the base plate 3 disclosed in FIGS. 1 to 3 the space 4 is a hole arranged through the base plate 3 in the thickness direction thereof. The space 4 is thus arranged to extend from a top surface 3′ or a front surface 3′ of the base plate 3 up to a bottom surface 3″ or a backside surface 3″ of the base plate 3.

The sensor 1 further comprises a silicon-on-insulator plate 5, i.e. a SOI plate 5, made of a silicon wafer and arranged on top of the base plate 3. The silicon-on-insulator plate 5 at least partly defines the resonance cavity 6 that is a free space extending horizontally and vertically in the sensor structure level provided by the silicon-on-insulator plate 5 in the sensor 1. The cavity 6 is located on top of the space 4 where the transducer 2 is arranged to remain, the cavity 6 being arranged to be open to the space 4 so that the transducer 2 is arranged to be connected to or to be in open connection with the cavity 6 when the transducer 2 is assembled in the sensor 1.

The ultrasound or the ultrasonic waves are generated into the cavity 6 by the transducer 2. The cavity 6 is also arranged to receive the substance or the agent to be identified or the property of which is to be measured, or arranged to be in connection with a phenomenon, such as sound or voice, the physical magnitude of which is to be measured. The cavity 6 may be formed of the silicon-on-insulator plate 5 by removing material from the silicon-on-insulator plate 5 for example by etching before it is stacked on top of the base plate 3 or after it has been stacked on top of the base plate 3.

Further the sensor 1 comprises a top element 7 on top of the silicon-on-insulator plate 5 for terminating the cavity 6. According to an embodiment of the sensor 1 the top element 7 is formed of a silicon wafer. The distance between the transducer 2 and the top element 7, or in other words a thickness of the silicon-on-insulator plate 5 determines a cavity length of the cavity 6, i.e. a vertical dimension of the cavity 6. For a proper operation of the sensor 1 the cavity length is dimensioned such that a resonance condition between the cavity 6 and the transducer 2 is met. Generally in resonance condition the cavity length is a half or a quarter of the wavelength of the ultrasound or the ultrasonic waves or any integer multiple of the half or the quarter of the wavelength of the ultrasound or the ultrasonic waves put out by the transducer 2.

When the sensor 1 is assembled, the transducer 2 may be inserted into the space 4 in the base plate 3 through the hole in the bottom surface 3″ of the base plate 3. A horizontal dimensioning of the cavity 6 is arranged to be smaller than a horizontal dimensioning of the space 4, whereby, when the transducer 2 is moved towards the front surface 3′ of the base plate 3, the transducer 2 will stop at its final location at the bottom of the cavity 6 when the transducer 2 meets the silicon-on-insulator plate 5 that at least partly defines the cavity 6.

After that the silicon-on-insulator plate 5 is stacked onto the base plate 3 and the cavity 6 is formed as disclosed above unless the cavity 6 has been manufactured earlier in the silicon-on-insulator plate 5. After that the top element 7 is stacked onto the silicon-on-insulator plate 5 for providing a sensor 1 having a three-layer structure. The different layers of the sensor 1, i.e. the base plate 3, the silicon-on-insulator plate 5 and the top element 7 as well as the transducer 2 are glued together with adhesive that does not deform when drying.

The sensor 1 of FIGS. 1 to 3 further comprises a flow channel 8 which is arranged in connection with the cavity 6 and which is at least partly defined by the silicon-on-insulator layer 5. The flow channel 8 is arranged to extend substantially horizontally through the silicon-on-insulator plate 5 via the cavity 6, whereby the transducer 2 forms a bottom of the flow channel 8 at the cavity 6. The flow channel 8 is intended for a fluid exchange or a gas exchange in the cavity 6 of the sensor 1 when the fluid or the gas flowing through the cavity 6 is the substance or the agent which is to be identified or the property of which is to be measured with the sensor 1. Alternatively the flow channel 8 will bring the phenomenon, the physical magnitude of which is to be measured, into the cavity 6 into contact with the transducer 2. In the embodiment of the sensor 1 disclosed in the FIGS. 1 to 3 both ends 8′ 8″ of the flow channel 8 are open out of the sensor 1 so that the fluid or the gas may flow into the flow channel 8 from the first end 8′ of the flow channel 8 and out of the flow channel 8 from the second end 8″ of the flow channel 8.

If the fluid is liquid, the fluid may be composed of only one liquid or it may be a mixture of two or more different liquids. Alternatively, if the fluid is gas, the fluid may be composed of only one gas or it may be a mixture of two or more different gases. Alternatively the fluid may be a mixture of at least one liquid and at least one gas. The gas may be composed of only one gas or it may be a mixture of two or more gases.

The flow channel 8 is formed of the silicon-on-insulator plate 5 by removing material from the silicon-on-insulator plate 5 after it has been stacked to the base plate 3 or before it is stacked on top of the base plate 3. The material removal may be implemented for example by etching. The bottom 8′″ of the flow channel 8 is thereby formed for example by an insulation layer of the silicon-on-insulator plate 5 at other portions of the flow channel 8 but not at the cavity 6 at which the material of the silicon-on-insulator plate 5 is totally removed so that at the cavity 6 the bottom 8′″ of the flow channel 8 is formed by the top surface of the transducer 2. Alternatively the bottom 8′″ of the flow channel 8 at other portions of the flow channel 8 but not at the cavity 6 is provided by the top surface 3′ of the base plate 3, which may be implemented by etching the silicon-on-insulator plate 5 up to the top surface 3′ of the base plate 3 or by forming the silicon-on-insulator plate 5 of two separate pieces that together form the silicon-on-insulator plate 5.

According to an embodiment of the sensor 1, the transducer 2 may be a capacitive micromachined ultrasonic transducer, i.e. a CMUT. In CMUTs, an energy transduction is due to a change in capacitance in the transducer 2. The transducer 2 has a silicon substrate 9 which is formed of a silicon wafer and provides a base 9 of the transducer 2. The transducer 2 comprises a vacuum space which is not shown in the Figures. The vacuum space of the transducer is formed in the silicon substrate 9. On top of the vacuum space of the transducer 2 there is a thin vibrating member 10, such as a thin membrane. The vibrating member 10 comprises a metallized layer that acts as an electrode, together with the silicon substrate 9 which serves as a bottom electrode.

In the embodiment of FIG. 4 the transducer 2 comprises a number of transducer elements 11 that are separate from each other, each element 11 having the vibrating member 10 of its own, meaning that the transducer 2 is formed as a composition of several transducer elements 11 wherein each element 11 provides an operable transducer unit. Some of the transducer elements 11 may put out the ultrasound and the rest of the transducer elements 11 may receive the ultrasound. According to another embodiment a single transducer 2 is arranged to both put out and receive the ultrasound. Electrical contacts of the transducer 2 are shown only very schematically with boxes denoted with reference signs 12, 13 and 14.

When an AC signal is applied across the biased electrodes, the vibrating membrane 10 will produce ultrasound or ultrasonic waves in the medium or the substance or the agent flowing in the flow channel 8 or being in another way in connection with the cavity 6 of the sensor 1 and the transducer 2 at the bottom of the cavity 6. In that case the transducer 2 works as a transmitter. On the other hand, when the ultrasound or the ultrasonic waves are received onto on the membrane 10 of the biased CMUT, it will generate alternating signal as the capacitance of the CMUT is varied, whereby the transducer 2 works as a receiver for ultrasound or ultrasonic waves.

According to an embodiment the transducer 2 may be a piezoelectric micromachined ultrasonic transducer, i.e. a PMUT. PMUTs are based on the flexural motion of a thin membrane which is coupled with a thin piezoelectric film. The transducer 2 implemented as a PMUT can also function as a transmitter and a receiver depending on the intended use of the sensor 1.

General structures and operation principles of the capacitive micromachined ultrasonic transducer and a piezoelectric micromachined ultrasonic transducer are known for a person skilled in the art and therefore they are not considered here in more detail.

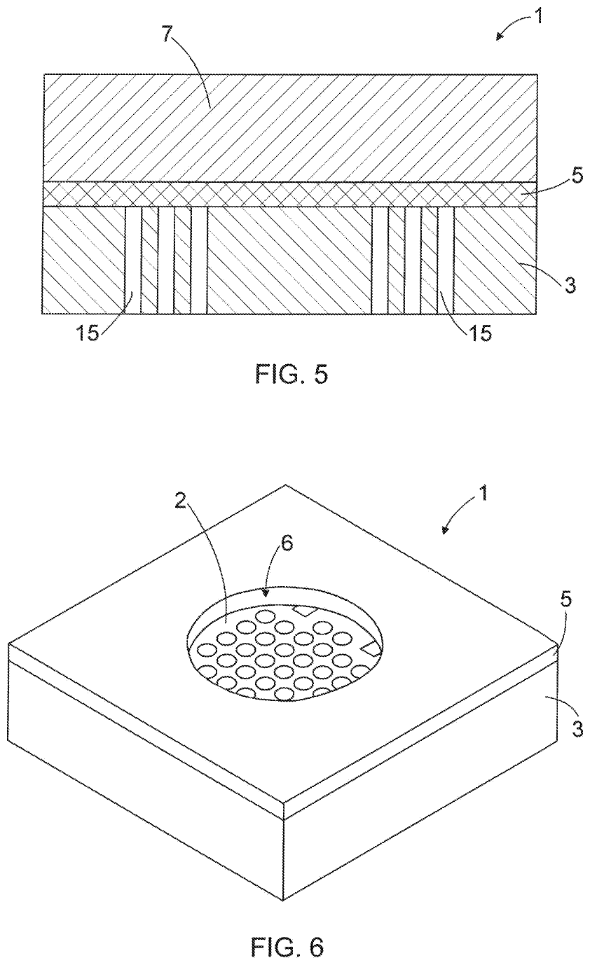

According to an embodiment of the sensor 1, the top element 7 is an Application Specific Integrated Circuit, an ASIC. When the top element 7 of the sensor 1 is the ASIC, the sensor 1 may form an independently operable unit, i.e. all the electronics needed for the operation of the sensor 1 may be contained by the sensor 1 itself, or in other words, all the necessary electronics needed for the operation of the sensor 1 may be embedded into the ASIC. The sensor 1 may comprise electrical feed-through connections 15 arranged through the base plate 3, whereby the sensor 1 may be assembled in connection to a circuit board of the actual device where the sensor is utilized via the electrical feed-through connections 15 extending through the base plate 3. A cross-sectional side view of a sensor 1 of this type is shown schematically in FIG. 5.

According to an embodiment of the sensor 1, the top element 7 is an element made of porous material, whereby one of a fluid exchange and a gas exchange in the cavity 6 of the sensor 1 may take place through the top element 7 made of porous material. In that type of the sensor 1 there are no flow channel 8 but as said the fluid exchange or the gas exchange in the cavity 6 of the sensor 1 may take place through the porous material of the top element 7. FIG. 6 shows schematically an axonometric view of a part of a type of the sensor 1 not comprising any flow channel 8. In the sensor 1 of FIG. 6 the top element 7 is not shown for the sake of clarity.

According to an embodiment of the sensor 1, the sensor 1 does not comprise any flow channel 8 but only the cavity 6, and the top element 7 is made of material not being porous, or in other words, the top element 7 is made of material not allowing any fluid flow or gas flow through the top element 7. That type of sensor 1 may be used as a reference sensor, for example.

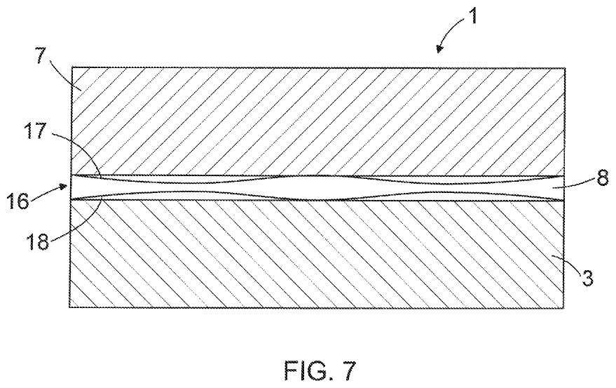

According to an embodiment of the sensor 1, the sensor 1 comprises a microelectromechanical system diaphragm pump 16 arranged in the flow channel 8 for enhancing the flow of fluid or gas through the flow channel 8. The sensor 1 comprising a microelectromechanical system diaphragm pump 16 is shown schematically in FIG. 7. The microelectromechanical system diaphragm pump 16 comprises two superimposed membranes 17, 18 between which the flow of fluid or gas takes place. The microelectromechanical system diaphragm pump 16 may for example be attached with the top element 7 of the sensor 1.

According to an embodiment of the sensor 1, the top element 7 is a micro hotplate. When the top element 7 is the micro hotplate, the cavity 6 and/or the flow channel 8 of the sensor 1 as well as the fluid or gas flowing in the flow channel 8 may be heated to a temperature suitable for the intended measurement operation or other intended application of the sensor 1.

Other implementations of the base plate 3 and the top element 7 as disclosed above are also possible. However, in case of each of the base plate 3 and the top element 7 being formed of a silicon wafer the sensor 1 provides a stacked sensor construction made out of three wafers and the transducer, whereby the sensor 1 has a simple and compact miniaturized structure which can be manufactured in a simple way. Furthermore, when the cavity 6 and also the flow channel 8 if there is any flow channel 8, are at least partly defined by the silicon-on-insulator plate 5 which also for its part leads to a compact and miniature version of the sensor 1. This means that a miniaturized cavity having a lateral size even as small as 1 mm, for example, may be provided. Further this means that an actual size of the sensor 1 as well as the size of the system or the device where the sensor 1 is arranged to may be very small.

The sensor 1 as presented may be used for various applications.

According to an embodiment, the sensor 1 may be used as a gas sensor. The sensor can for example be used to measure both a damping and either a speed or a velocity of the ultrasound in the gas, whereby the gas can be determined or identified based on these measurements. Because the damping and the speed and velocity of the ultrasound depend on temperature and humidity of the gas, an accurate measurement may also require the measurement of the temperature and humidity. The humidity of the gas may also be determined only from the damping of the ultrasound if measured in a broad frequency range.

If the top element is implemented as a micro hotplate or if the top element comprises a micro hotplate, the temperature and/or humidity of the gas to be measured may be arranged to be a specific predetermined constant. In that case temperature and/or humidity measurement are not needed. This may be achieved for example by arranging the cavity to have a temperature that is substantially high relative to the temperature of ambient of the sensor.

The sensor 1 may be used correspondingly to determine or identify other fluids, such as liquids.

The sensor 1 having the top element 7 being formed of the micro hotplate or comprising the micro hotplate may also be used as a combo gas sensor. The sensor 1 of this type may be arranged to measure the properties of inert gases by using the ultrasound or ultrasonic waves provided by the transducer 2 as well as the properties of volatile organic compounds by using a micro pellistor technique utilizing the micro hotplate to heat the gas flowing in the cavity 6 and in the flow channel 8 of the sensor 1. In the micro pellistor technique the sensor 1 comprises also a detecting element consisting of small pellets or thin film of catalyst loaded ceramic whose resistance changes in the presence of the gas. Some of the pellets or thin films of catalyst loaded ceramic require a gentle heating in use what may be provided by the micro hotplate.

According to an embodiment, the sensor 1 may be used as a pressure sensor. The pressure of the fluid or gas can be measured by determining a deflection of the vibrating membrane of the transducer 2 because of the fluid or gas affecting through the flow channel 8 and the cavity 6 to the vibrating membrane 10 of the transducer 2. This causes a change in the impedance of the transducer 2 which indicates the pressure of the fluid or gas.

According to an embodiment, the sensor 1 may be used as a magnetometer. In this application a coil, in which either direct current or alternating current travels, is arranged on top of the membrane of the transducer, whereby the membrane will either move or oscillate as a function of the external magnetic field. In the case of direct current the change in the impedance is determined, whereas in the case of alternating current impedance modulation taking place in the sensor 1 is inspected.

According to an embodiment, the sensor 1 may be used as a microphone. In this application the movement of the membrane 10 of the transducer 2 is measured, the movement of the membrane being directly proportional to the pressure and the effective surface area of the membrane 10 of the transducer 2.

In addition to the application areas listed above, the sensor 1 may also be utilized for location, velocity, acceleration, surface roughness and vibration measurement applications.

The measurement principle using the ultrasound or the ultrasonic waves for the applications mentioned above, or for other applications not specifically listed above, are generally known for a person skilled in the art and therefore they are not described herein in more detail. For example WO-publication 2009/071746 A1 discloses some possible applications listed above in more detail.

It will be obvious to a person skilled in the art that, as the technology advances, the inventive concept can be implemented in various ways. The invention and its embodiments are not limited to the examples described above but may vary within the scope of the claims.

1. A sensor comprising
an ultrasonic transducer,
a base plate comprising a space for accommodating the transducer, the base plate forming a frame for the transducer,
a silicon-on-insulator plate on top of the base plate, the silicon-on-insulator plate at least partly defining a horizontally and vertically extending resonance cavity arranged in connection with the transducer, and
a top element on top of the silicon-on-insulator plate for terminating the cavity, wherein the top element is a micro hotplate.

2. A sensor as claimed in claim 1, wherein the silicon-on-insulator plate comprises a flow channel for a fluid exchange or a gas exchange in the sensor, the flow channel being arranged in connection with the cavity and being at least partly defined by the silicon-on-insulator plate.

3. A sensor as claimed in claim 2, wherein the flow channel is arranged to extend substantially horizontally through the silicon-on-insulator plate via the cavity and the transducer is arranged to form a bottom of the flow channel at the cavity.

4. A sensor as claimed in claim 1, wherein at least one of the cavity and the flow channel is formed by removing material away from the silicon-on-insulator plate.

5. A sensor as claimed in claim 1, wherein the sensor is a gas sensor.

6. A sensor as claimed in claim 1, wherein the base plate is of silicon wafer.

7. A sensor as claimed in claim 1, wherein the transducer is one of a capacitive micromachined ultrasonic transducer and a piezoelectric micromachined ultrasonic transducer.

8. A sensor as claimed in claim 1, wherein the sensor comprises a microelectromechanical system diaphragm pump arranged in the flow channel.

9. A sensor as claimed in claim 1, wherein the top element is an Application Specific Integrated Circuit (ASIC).

10. A sensor as claimed in claim 9, wherein the sensor comprises electrical feed-through connections arranged through the base plate for the Application Specific Integrated Circuit (ASIC) being the top element of the sensor.

11. (canceled)

12. A sensor as claimed in claim 1, wherein the sensor is arranged to measure inert gases by the transducer and volatile organic compounds with micro pellistor technique utilizing the micro hotplate.

13. A sensor as claimed in claim 1, wherein the top element is an element made of porous material, one of the fluid exchange and the gas exchange in the sensor taking place through the top element made of porous material.
